(19) United States
(12) Patent Application Publication
(10) Pub. No.: US 2026/0166742 A1
(43) Pub. Date: Jun. 18, 2026

(54) CONTROL DEVICE, THREE-DIMENSIONAL POSITION MEASURING SYSTEM, AND PROGRAM

(71) Applicant: Fanuc Corporation, Minamitsuru-gun, Yamanashi (JP)

(72) Inventor: Yuta NAMIKI, Minamitsuru-gun, Yamanashi (JP)

(73) Assignee: Fanuc Corporation, Minamitsuru-gun, Yamanashi (JP)

(21) Appl. No.: 19/124,399

(22) PCT Filed: Nov. 17, 2022
(86) PCT No.: PCT/JP2022/042699

§ 371 Date: Apr. 25, 2025

(51) Int. Cl. B25J 9/16; G06T 7/73

(52) U.S. Cl. CPC B25J 9/1692; B25J 9/163; B25J 9/1664; B25J 9/1674; B25J 9/1697; G06T 7/74

(57) ABSTRACT

A control device includes: a combination generating unit which generates a plurality of combinations in which three or more detection targets are selected from among three or more detection targets that are on a workpiece and have a known positional relationship with each other and that are detected based on an image captured by a visual sensor; a selection unit that selects one or more combinations from the plurality of combinations on the basis of an index representing a positional deviation of the detected positions of the three or more detection targets from an ideal position, said positional deviation being calculated for each combination of the generated plurality of combinations; and a three-dimensional position determination unit that determines the three-dimensional position of the workpiece from the selected one or more combinations.

### CROSS REFERENCE TO RELATED APPLICATIONS

This is the U.S. National Phase application of PCT/JP2022/042699, filed Nov. 17, 2022, the disclosure of this application being incorporated herein by reference in its entirety for all purposes.

### FIELD OF THE INVENTION

The present disclosure relates to a control device, a three-dimensional position measurement system, and a program.

### BACKGROUND OF THE INVENTION

Various measurement systems for measuring a three-dimensional position of a three-dimensional object by using a visual sensor have been proposed. For example, PTLs 1 and 2 describe a method for detecting, by three cameras, each of three detection targets having a known mutual positional relationship on a three-dimensional object, and measuring a three-dimensional position of the three-dimensional object from detected positions of the three detection targets.

In relation to three-dimensional position measurement, PTL 3 describes a method for creating a three-dimensional model used for three-dimensional recognition processing using a stereo camera. PTL 4 describes an example of a method for performing a three-dimensional measurement of a position and a posture of an article conveyed by a conveyor.

### PATENT LITERATURE

[PTL 1] Japanese Unexamined Patent Publication (Kokai) No. H07-13613 A
[PTL 2] Japanese Unexamined Patent Publication (Kokai) No. S62-54115 A
[PTL 3] Japanese Unexamined Patent Publication (Kokai) No. 2010-121999 A
[PTL 4] Japanese Unexamined Patent Publication (Kokai) No. 2019-128274 A

### SUMMARY OF THE INVENTION

In the case of a configuration for detecting three detection targets on a three-dimensional object, and obtaining a three-dimensional position of the three-dimensional object from detected positions of the three detection targets as described in PTLs 1 and 2, a measurement result may include an error of a position of the detection target itself and a measurement error in a detected position of the detection target. Thus, there may be a case where sufficient accuracy is not acquired from measurement of the three-dimensional object by the detected positions of the three detection targets. Further, when an error of a part of the three detection targets is great, the total error, i.e., a three-dimensional position measurement result of the three-dimensional object may also be great due to the error of the part of the three detection targets.

A technique that can reduce the influence of an error that may be included in a detected position of a detection target, and thus improved accuracy of measurement of a three-dimensional position of a three-dimensional object is desired.

One aspect of the present disclosure is a controller including: a combination generation unit configured to generate a plurality of combinations each of which is acquired by selecting three or more detection targets from among detection targets detected based on an image in which three or more detection targets being present on a workpiece and having a known positional relationship with one another are captured by a visual sensor; a selection unit configured to select one or more combinations from the plurality of combinations, based on an indicator representing a positional deviation of detected positions of the three or more detection targets from an ideal position, the indicator being calculated for each of the plurality of generated combinations; and a three-dimensional position determination unit configured to determine a three-dimensional position of the workpiece from the one or more selected combinations.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system including a robot controller according to an embodiment.

FIG. 2 is a diagram illustrating a car body and a detection target as an actual example of a workpiece.

FIG. 3 is a diagram illustrating a vision coordinate system, and a sensor coordinate system assigned to each reference point located in a zero deviation position on a workpiece.

FIG. 4 is a diagram illustrating a projection of the sensor coordinate system and a reference point to an image plane.

FIG. 5 is a functional block diagram of the robot controller and an image processing device.

FIG. 6 is a flowchart illustrating a basic motion of three-dimensional position measurement processing.

### DETAILED DESCRIPTION OF EMBODIMENTS OF THE INVENTION

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

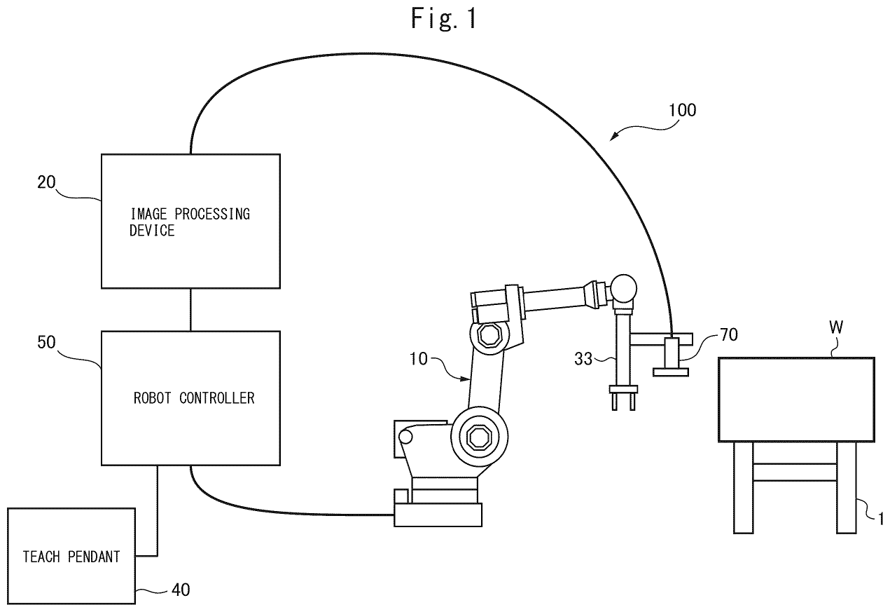

FIG. 1 is a diagram illustrating a configuration of robot system 100 including robot controller 50 according to an embodiment. As illustrated in FIG. 1, robot system 100 includes robot 10, visual sensor 70 mounted on a tip portion of robot 10, robot controller 50 that controls robot 10, teach pendant 40, and image processing device 20. Teach pendant 40 and image processing device 20 are connected to robot controller 50. Visual sensor 70 is connected to image processing device 20. Robot system 100 according to the present embodiment is configured as a three-dimensional position measurement system capable of highly accurately measuring a three-dimensional position of workpiece W being a three-dimensional object arranged on table 1 (such as a carriage on a conveyance device, and a stand) by detecting three or more detection targets on workpiece W.

Robot 10 is assumed to be a vertical articulated robot. It should be noted that a robot of other types such as a horizontal articulated robot, a parallel link robot, or a dual arm robot may be used as robot 10 according to a work target. Robot 10 can perform desired work by an end effector attached to a wrist portion. The end effector is an external device exchangeable according to use, and is, for example, a hand, a welding gun, a tool, and the like. FIG. 1 illustrates an example in which hand 33 as the end effector is used.

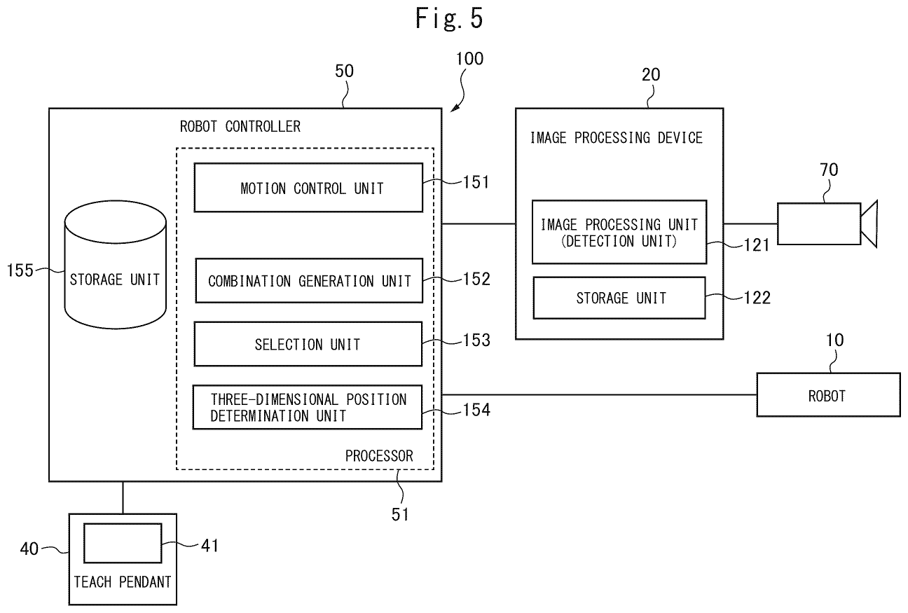

Robot controller 50 controls a motion of robot 10 according to a motion program or a command from the teach pendant 40. Robot controller 50 may have a hardware configuration as a general computer including processor 51 (FIG. 5), a memory (such as a ROM, a RAM, and a non-volatile memory), a storage device, an operation unit, an input/output interface, a network interface, and the like.

Image processing device 20 has a function of controlling visual sensor 70, and a function of executing image processing including detection processing of a target object and the like. Image processing device 20 may have a hardware configuration as a general computer including a processor, a memory (such as a ROM, a RAM, and a non-volatile memory), a storage device, an operation unit, a display unit, an input/output interface, a network interface, and the like.

It should be noted that FIG. 1 illustrates a configuration example in which the image processing device having the functions of control of visual sensor 70 and the image processing is provided as an independent device in the robot system 100, but the functions as image processing device 20 may be integrally incorporated in robot controller 50.

Teach pendant 40 is used as an operation terminal for performing teaching and various types of setting of robot 10. A teaching device formed of a tablet computer and the like may be used as teach pendant 40. Teach pendant 40 may have a hardware configuration as a general computer including a processor, a memory (such as a ROM, a RAM, and a non-volatile memory), a storage device, an operation unit, display unit 41 (FIG. 5), an input/output interface, a network interface, and the like.

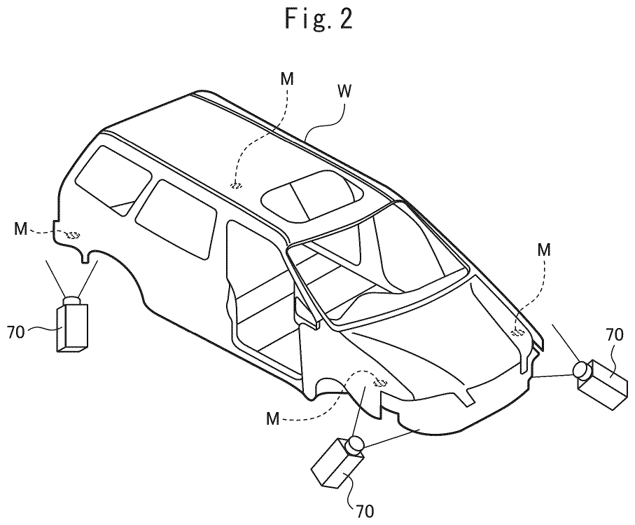

Workpiece W being a target of three-dimensional position measurement is, for example, a car body as illustrated in FIG. 2. Workpiece W is provided with three or more detection targets (for example, a circular hole M) in positions having a known positional relationship with one another. The detection target is arranged on, for example, a bottom surface of a car body. Robot system 100 calculates a three-dimensional position of the entire workpiece W by detecting the positions of the three or more detection targets by visual sensor 70. Robot system 100 can acquire a three-dimensional position of workpiece W, and appropriately perform various types of work on workpiece W.

FIG. 1 illustrates the configuration example of a case where visual sensor 70 is mounted on the tip of robot 10. In this configuration, visual sensor 70 is moved by robot 10, and visual sensor 70 is positioned in each capturing position for capturing the detection target (circular hole M), and captures and detects the detection target. A capturing position in which each detection target of workpiece W located in a reference position can be captured may be taught in advance to robot 10.

Instead of the configuration in which the visual sensor is mounted on robot 10, a configuration in which a detection target is captured and detected by one or more visual sensors fixedly arranged in a workspace may be adopted. In this case, a plurality of visual sensors that capture each of a plurality of detection targets on a workpiece may be arranged. Alternatively, one visual sensor may be arranged in a position in which the visual sensor captures two or more detection targets. In the latter case, the number of visual sensors being arranged can be smaller than a total number of detection targets.

A capturing position (posture) of a detection target by visual sensor 70 follows a restriction that image planes in any capturing position (posture) of the visual sensor should not also be planar to each other. It should be noted that normal vectors with respect to any image plane also preferably form a considerable angle.

Robot system 100 (robot controller 50) detects positions of three or more detection targets on workpiece W, and obtains a three-dimensional position of workpiece W based on the detected positions. Hereinafter, a technique for detecting positions of three detection targets on a workpiece, which is a basic detection technique, will be described, and then a technique for extending the technique to four or more detection targets will be described. Then, determination of a three-dimensional position of a three-dimensional object, based on detected positions of the three or more detection targets will be described.

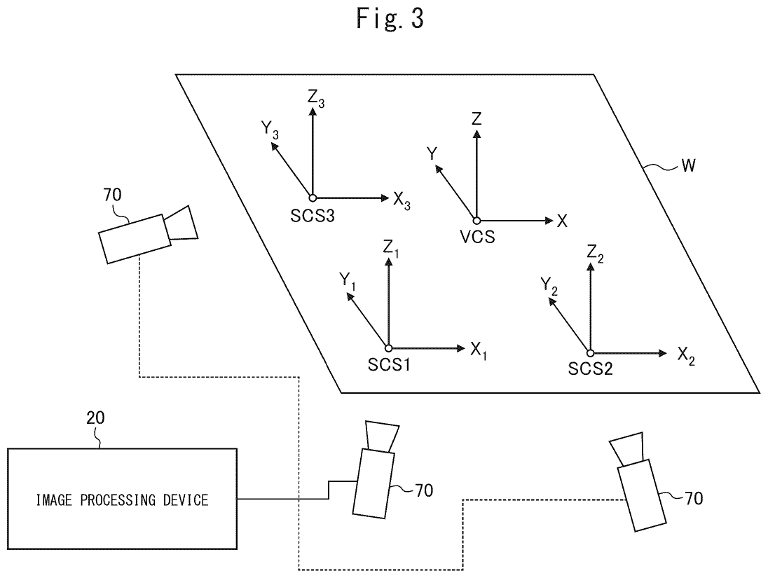

The technique for detecting three detection targets on workpiece W and obtaining a three-dimensional position of the workpiece will be described. A “position detection function” of detecting positions of three detection targets on workpiece W may be provided as a function of image processing unit (detection unit) 121 (FIG. 5) of image processing device 20. As illustrated in FIG. 3, workpiece W can be considered as a rigid body having three known points (detection targets). When workpiece W is located in a zero deviation position, i.e., an ideal nominal position, a vision coordinate system (hereinafter also described as a VCS) being a local coordinate system located on workpiece W or the origin in the vicinity of workpiece W is considered. Three orthogonal vectors are provided upright with, as a starting point, a point associated with each of detection targets (herein also described as reference points) located in positions providing a zero deviation, a size of the vectors is a unit length, and a direction thereof is parallel to a direction of three vectors in the vision coordinate system VCS. Small coordinate systems created in each point by three unit vectors are referred to as sensor coordinate systems 1, 2, and 3 (also described as SCS1, SCS2, and SCS3). Transformation of the three sensor coordinate systems is invariable.

The vision coordinate system VCS is assumed to have a fixed relationship with a capturing position (posture) of visual sensor 70. A coordinate system fixed in workpiece W is referred to as a workpiece coordinate system (also described as a BCS). When workpiece W is located in a zero deviation position, each reference point accurately corresponds to each origin of the three sensor coordinate systems.

When workpiece W moves from the zero deviation position, movement of a rigid body received by workpiece W is completely determined by transformation [T] that relates the VCS to the BCS. The transformation is transformation defined with regard to the VCS, and a position and an azimuth of the BCS and thus a position of workpiece W are completely determined by the transformation.

When a zero deviation position coordinate of a reference point in the VCS and a position coordinate occupied when the reference point is displaced are provided, the zero deviation position coordinate and the displaced position coordinate are directly related to each other by the transformation [T]. To be able to determine the transformation [T] by detecting a reference point in a visual field of visual sensor 70 in each capturing position is a purpose of a three-dimensional position determination function described below.

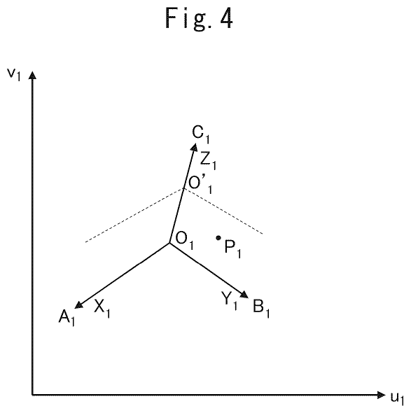

When the workpiece W is located in a position having a slight deviation, a reference point on an image plane moves to a position away from the origin of the SCS coordinate system. FIG. 4 illustrates a projection of the SCS1 coordinate system and a reference point P₁ to the image plane in this case. In general, by combining three or more projections onto the image plane with calibration data, six degrees of freedom in a deviation from a nominal position of a three-dimensional object can be determined. On an assumption that the point P₁ is located on an X-Y plane of the SCS1 coordinate system, a position of the point P₁ can be solved from capturing images in each camera position independently of each other. Vectors A, B, and P are defined as follows. u is a horizontal axis on the image plane, and v is a vertical axis on the image plane. u and v with a hat are correspondingly unit vectors in a horizontal axis direction and a vertical axis direction of the image plane.

$$[ Mathematical 1 ]$$

$$P = {P}_{1} - {O}_{1} = ( {u}_{P 1} - {u}_{O 1} ) \hat{u} + ( {v}_{P 1} - {v}_{O 1} ) \hat{v}$$

$$A = {A}_{1} - {O}_{1} = ( {u}_{A 1} - {u}_{O 1} ) \hat{u} + ( {v}_{A 1} - {v}_{O 1} ) \hat{v}$$

$$B = {B}_{1} - {O}_{1} = ( {u}_{B 1} - {u}_{O 1} ) \hat{u} + ( {v}_{B 1} - {v}_{O 1} ) \hat{v}$$

$$P = ( {u}_{P 101} ) \hat{u} + ( {v}_{P 101} ) \hat{v}$$

$$A = ( {u}_{A 101} ) \hat{u} + ( {v}_{A 101} ) \hat{v}$$

$$B = ( {u}_{B 101} ) \hat{u} + ( {v}_{B 101} ) \hat{v}$$

$${O}_{1} = ( {u}_{O 1} ) \hat{u} + ( {v}_{O 1} ) \hat{v}$$

$${P}_{1} = ( {u}_{P 1} ) \hat{u} + ( {v}_{P 1} ) \hat{v}$$

$${A}_{1} = ( {u}_{A 1} ) \hat{u} + ( {v}_{A 1} ) \hat{v}$$

$${B}_{1} = ( {u}_{B 1} ) \hat{u} + ( {v}_{B 1} ) \hat{v}$$

The vector A and the vector B are projections of a unit vector in an X direction and a unit vector in a Y direction in the SCS1 coordinate system to the image plane. An X coordinate and a Y coordinate (i.e., x1 and y1) of the point P₁ are provided from equations (1) to (4) indicated below.

$$[ Mathematical 2 ]$$

$$P = {x}_{1} A + {y}_{1} B \qquad ( 1 )$$

$$P = ( {u}_{P 101} ) \hat{u} + ( {v}_{P 101} ) \hat{v} \qquad ( 2 )$$

$$P = {x}_{1} [ ( {u}_{A 101} ) \hat{u} + ( {v}_{A 101} ) \hat{v} ] + {y}_{1} [ ( {u}_{B 101} ) \hat{u} + ( {v}_{B 101} ) \hat{v} ] \qquad ( 3 )$$

$$\begin{matrix}{u}_{P 101} = {x}_{1} {u}_{A 101} + {y}_{1} {u}_{B 101} \\ {v}_{P 101} = {x}_{1} {v}_{A 101} + {y}_{1} {v}_{B 101}\end{matrix} \} \qquad ( 4 )$$

$${x}_{1} = \frac{\vert \begin{matrix}{u}_{P 101} & {u}_{B 101} \\ {v}_{P 101} & {v}_{B 101}\end{matrix} \vert}{\vert \begin{matrix}{u}_{A 101} & {u}_{B 101} \\ {v}_{A 101} & {v}_{B 101}\end{matrix} \vert}$$

$${y}_{1} = \frac{\vert \begin{matrix}{u}_{A 101} & {u}_{P 101} \\ {v}_{A 101} & {v}_{P 101}\end{matrix} \vert}{\vert \begin{matrix}{u}_{A 101} & {u}_{B 101} \\ {v}_{A 101} & {v}_{B 101}\end{matrix} \vert}$$

With reference to FIG. 4, a case of a more generalized manner is represented by equations (5) to (9) below. In this case, it is assumed that z may take any value.

$$[ Mathematical 3 ]$$

$$\begin{matrix}{O}_{1}^{′} = {O}_{1} + {z}_{1} ( {C}_{1} - {O}_{1} ) \\ = ( {u}_{O} + {z}_{1} {u}_{co} ) \hat{u} + ( {v}_{O} + {z}_{1} {v}_{co} ) \hat{v}\end{matrix} \qquad ( 5 )$$

$$\begin{matrix}{P}^{′} = {P}_{1} - {O}_{1} \\ = ( {u}_{P} - {u}_{O} - {z}_{1} {u}_{co} ) \hat{u} + ( {v}_{P} - {v}_{O} - {z}_{1} {v}_{co} ) \hat{v}\end{matrix} \qquad ( 6 )$$

$$A = {A}_{1} - {O}_{1} = ( {u}_{AO} ) \hat{u} + ( {v}_{AO} ) \hat{v} \qquad ( 7 )$$

$$B = {B}_{1} - {O}_{1} = ( {u}_{BO} ) \hat{u} + ( {v}_{BO} ) \hat{v} \qquad ( 8 )$$

$${P}^{′} = {x}_{1} A + {y}_{1} B \qquad ( 9 )$$

From the equations (5) to (9), equations (10) to (11) are acquired, and a solution in which x1 and y1 are represented by z1 is acquired.

$$[ Mathematical 4 ]$$

$$( {u}_{P} - {u}_{O} - {z}_{1} {u}_{co} ) \hat{u} + ( {v}_{P} - {v}_{O} - {z}_{1} {v}_{co} ) \hat{v} = {x}_{1} [ ( {u}_{AO} ) \hat{u} + ( {v}_{AO} ) \hat{v} ] + {y}_{1} [ ( {u}_{BO} ) \hat{u} + ( {v}_{BO} ) \hat{v} ] \qquad ( 10 )$$

$${u}_{PO} - {z}_{1} {u}_{CO} = {x}_{1} {u}_{AO} + {y}_{1} {u}_{BO} \qquad ( 11 )$$

$${v}_{PO} - {z}_{1} {v}_{CO} = {x}_{1} {v}_{AO} + {y}_{1} {v}_{BO}$$

$${x}_{1} = \frac{\vert \begin{matrix}( {u}_{PO} - {z}_{1} {u}_{CO} ) & {u}_{BO} \\ ( {v}_{PO} - {z}_{1} {v}_{CO} ) & {v}_{BO}\end{matrix} \vert}{\vert \begin{matrix}{u}_{AO} & {u}_{BO} \\ {v}_{AO} & {v}_{BO}\end{matrix} \vert}$$

$${y}_{1} = \frac{\vert \begin{matrix}{u}_{AO} & ( {u}_{PO} - {z}_{1} {u}_{CO} ) \\ {v}_{AO} & ( {v}_{PO} - {z}_{1} {v}_{CO} )\end{matrix} \vert}{\vert \begin{matrix}{u}_{AO} & {u}_{BO} \\ {v}_{AO} & {v}_{BO}\end{matrix} \vert}$$

x1 and y1 described above are rewritten as follows.

$$[ Mathematical 5 ]$$

$$\begin{matrix}{x}_{1} = {α}_{1} {z}_{1} + {β}_{1} \\ {y}_{1} = {γ}_{1} {z}_{1} + {δ}_{1}\end{matrix} \} \qquad ( 12 )$$

Herein, α1, β1, γ1, and δ1 are constants provided by the following equations.

$$[ Mathematical 6 ]$$

$${α}_{1} = \frac{- \vert \begin{matrix}{u}_{CO} & {u}_{BO} \\ {v}_{CO} & {v}_{BO}\end{matrix} \vert}{\vert \begin{matrix}{u}_{AO} & {u}_{BO} \\ {v}_{AO} & {v}_{BO}\end{matrix} \vert}$$

$${β}_{1} = \frac{\vert \begin{matrix}{u}_{PO} & {u}_{BO} \\ {v}_{PO} & {v}_{BO}\end{matrix} \vert}{\vert \begin{matrix}{u}_{AO} & {u}_{BO} \\ {v}_{AO} & {v}_{BO}\end{matrix} \vert}$$

$${γ}_{1} = \frac{- \vert \begin{matrix}{u}_{AO} & {u}_{CO} \\ {v}_{AO} & {v}_{CO}\end{matrix} \vert}{\vert \begin{matrix}{u}_{AO} & {u}_{BO} \\ {v}_{AO} & {v}_{BO}\end{matrix} \vert}$$

$${δ}_{1} = \frac{\vert \begin{matrix}{u}_{AO} & {u}_{PO} \\ {v}_{AO} & {v}_{PO}\end{matrix} \vert}{\vert \begin{matrix}{u}_{AO} & {u}_{BO} \\ {v}_{AO} & {v}_{BO}\end{matrix} \vert}$$

An equation (12) indicates that both of x1 and y1 are linear functions of z1. A similar equation is also derived for other two image planes. A complete group of the equations is provided by equations (13) to (15). Various constants appearing in the equations (13) to (15) can be acquired by calibration using a calibration jig. As the calibration jig, for example, a cube having ridge lines and scales corresponding to coordinate axes orthogonal to one another in the SCS coordinate system is positioned in such a way that the three ridge lines are parallel to the coordinate axes orthogonal to one another in the SCS coordinate system. Then, the cube is captured, by visual sensor 70, in a position and a posture in which the reference point (SCS coordinate system) is captured, and information (calibration data) about what kind of vector the unit vectors of the X, Y, and Z axes in the SCS coordinate system correspond to on an image can be acquired by using information about actual dimensions of the cube. Such calibration data are stored in advance in storage unit 122 (FIG. 5) of image processing device 20, and the like.

$$[ Mathematical 7 ]$$

$${x}_{1} = {α}_{1} {z}_{1} + {β}_{1} \qquad ( 13 )$$

$${y}_{1} = {γ}_{1} {z}_{1} + {δ}_{1}$$

$${x}_{2} = {α}_{2} {z}_{2} + {β}_{2} \qquad ( 14 )$$

$${y}_{2} = {γ}_{2} {z}_{2} + {δ}_{2}$$

$${x}_{3} = {α}_{3} {z}_{3} + {β}_{3} \qquad ( 15 )$$

$${y}_{3} = {γ}_{3} {z}_{3} + {δ}_{3}$$

The equations (13) to (15) are six linear equations having nine unknowns. In order to solve the equations, a fact that a workpiece is a rigid body is considered as an additional constraint condition. In other words, a condition that a distance between reference points on a workpiece is fixed is used herein. The origins in each SCS coordinate system are each represented as (XO₁, YO₁, Z_{O1}), (X_{O2}, Y_{O2}, Z_{O2}), and (X_{O3}, Y_{O3}, Z_{O3}), and the origins of each reference point after displacement are represented as P₁ (X₁, Y₁, Z₁), P₂ (X₂, Y₂, Z₂), and P₃ (X₃, Y₃, Z₃). A distance between the origins in the three SCS coordinate systems is represented as follows, and a distance between the reference points after displacement is provided as in an equation (16).

$$[ Mathematical 8 ]$$

$${d}_{12} = \vert \overline{{O}_{1} {O}_{2}} \vert = \vert \overline{{P}_{1} {P}_{2}} \vert$$

$${d}_{23} = \vert \overline{{O}_{2} {O}_{3}} \vert = \vert \overline{{P}_{2} {P}_{3}} \vert$$

$${d}_{31} = \vert \overline{{O}_{3} {O}_{1}} \vert = \vert \overline{{P}_{3} {P}_{1}} \vert$$

$${d}_{12} = {[ {( {x}_{O 1} - {x}_{O 2} )}^{2} + {( {y}_{O 1} - {y}_{O 2} )}^{2} + {( {z}_{O 1} - {z}_{O 2} )}^{2} ]}^{1 / 2}$$

$${d}_{12} = {[ {x}_{O 12}^{2} + {y}_{O 12}^{2} + {z}_{O 12}^{2} ]}^{1 / 2}$$

$${d}_{23} = {[ {x}_{O 23}^{2} + {y}_{O 23}^{2} + {z}_{O 23}^{2} ]}^{1 / 2}$$

$${d}_{31} = {[ {x}_{O 31}^{2} + {y}_{O 31}^{2} + {z}_{O 31}^{2} ]}^{1 / 2}$$

$$[ Mathematical 9 ]$$

$$\begin{matrix}{d}_{12}^{2} = {( {x}_{O 12} + {x}_{1} - {x}_{2} )}^{2} + {( {y}_{O 12} + {y}_{1} - {y}_{2} )}^{2} + {( {z}_{O 12} + {z}_{1} - {z}_{2} )}^{2} \\ {d}_{23}^{2} = {( {x}_{O 23} + {x}_{2} - {x}_{3} )}^{2} + {( {y}_{O 23} + {y}_{2} - {y}_{3} )}^{2} + {( {z}_{O 23} + {z}_{2} - {z}_{3} )}^{2} \\ {d}_{31}^{2} = {( {x}_{O 31} + {x}_{3} - {x}_{1} )}^{2} + {( {y}_{O 31} + {y}_{3} - {y}_{1} )}^{2} + {( {z}_{O 31} + {z}_{3} - {z}_{1} )}^{2}\end{matrix} \} \qquad ( 16 )$$

By substituting the equations (13) to (15) for the equation (16), a first group (equation (17)) of the equations below is acquired. Further, a second group (equation (18)) of equations by rewriting the equations is acquired. k, l, and m in the equations are constants.

$$[ Mathematical 10 ]$$

$${( {x}_{O 12} + {α}_{1} {z}_{1} + {β}_{1} - {α}_{2} {z}_{2} - {β}_{2} )}^{2} + {( {y}_{O 12} + {γ}_{1} {z}_{1} + {δ}_{1} - {γ}_{2} {z}_{2} - {δ}_{2} )}^{2} + {( {z}_{O 12} + {z}_{1} - {z}_{2} )}^{2} = {d}_{12}^{2} \qquad ( 17 )$$

$${( {x}_{O 23} + {α}_{2} {z}_{2} + {β}_{2} - {α}_{3} {z}_{3} - {β}_{3} )}^{2} + {( {y}_{O 23} + {γ}_{2} {z}_{2} + {δ}_{2} - {γ}_{3} {z}_{3} - {δ}_{3} )}^{2} + {( {z}_{O 23} + {z}_{2} - {z}_{3} )}^{2} = {d}_{23}^{2}$$

$${( {x}_{O 31} + {α}_{3} {z}_{3} + {β}_{3} - {α}_{1} {z}_{1} - {β}_{1} )}^{2} + {( {y}_{O 31} + {γ}_{3} {z}_{3} + {δ}_{3} - {γ}_{1} {z}_{1} - {δ}_{1} )}^{2} + {( {z}_{O 31} + {z}_{3} - {z}_{1} )}^{2} = {d}_{31}^{2}$$

$$[ Mathematical 11 ]$$

$${k}_{11} {z}_{1}^{2} + {k}_{10} {z}_{1} + {k}_{20} {z}_{2} + {k}_{12} {z}_{1} {z}_{2} + {k}_{22} {z}_{2}^{2} + {k}_{00} = 0 \qquad ( 18 )$$

$${l}_{22} {z}_{2}^{2} + {l}_{20} {z}_{2} + {l}_{30} {z}_{3} + {l}_{23} {z}_{2} {z}_{3} + {l}_{33} {z}_{3}^{2} + {l}_{00} = 0$$

$${m}_{33} {z}_{3}^{2} + {m}_{30} {z}_{3} + {m}_{10} {z}_{1} + {m}_{31} {z}_{3} {z}_{1} + {m}_{11} {z}_{1}^{2} + {m}_{00} = 0$$

The second group (equation (18)) of the equations described above is solved by, for example, using an iterative method by Newton's method. When the values are obtained, x1, x2, x3 and y1, y2, y3 are acquired by substituting the values for the equations (13) to (15). (x1, y1, z1), (x2, y2, z2), and (x3, y3, z3) acquired in this way are positions on each of the SCS coordinate systems after displacement of each reference point. The positions may be transformed into values on the VSC. In this way, the transformation [T] that relates the VCS to the BCS can be acquired. In other words, a three-dimensional position of the workpiece W after displacement is acquired.

It should be noted that, in the technique described above, an orthogonal projection of three reference points onto an image plane is assumed. By considering that the actual projection is similar to a perspective projection, the processing of compensating for an error of a mapping relationship may be performed. In order to compensate for the error, a mapping relationship provided by the following equation is established between an actual coordinate axis and each projection axis of the actual coordinate axis. The mapping relationship with respect to each axis can be acquired by performing measurement of three or more points on each coordinate axis at a time of calibration and using an interpolation method for acquiring a necessary relationship.

$$[ Mathematical 12 ]$$

$${x}_{1}^{′} = {f}_{11} ( {x}_{1} ) , {y}_{1}^{′} = {f}_{12} ( {y}_{1} ) , {z}_{1}^{′} = {f}_{13} ( {z}_{1} )$$

$${x}_{2}^{′} = {f}_{21} ( {x}_{2} ) , {y}_{2}^{′} = {f}_{22} ( {y}_{2} ) , {z}_{2}^{′} = {f}_{23} ( {z}_{2} )$$

$${x}_{3}^{′} = {f}_{31} ( {x}_{3} ) , {y}_{3}^{′} = {f}_{32} ( {y}_{3} ) , {z}_{3}^{′} = {f}_{33} ( {z}_{3} )$$

$${λ}_{1} = {x}_{1} / {x}_{1}^{′} {μ}_{1} = {y}_{1} / {y}_{1}^{′} {η}_{1} = {z}_{1} / {z}_{1}^{′}$$

$${λ}_{2} = {x}_{2} / {x}_{2}^{′} {μ}_{2} = {y}_{2} / {y}_{2}^{′} {η}_{2} = {z}_{2} / {z}_{2}^{′}$$

$${λ}_{3} = {x}_{3} / {x}_{3}^{′} {μ}_{3} = {y}_{3} / {y}_{3}^{′} {η}_{3} = {z}_{3} / {z}_{3}^{′}$$

A calculation result of a new scale factor is indicated below.

$$[ Mathematical 13 ]$$

$${α}_{1}^{′} = ( \frac{{η}_{1}}{{λ}_{1}} ) {α}_{1} , {β}_{1}^{′} = ( \frac{1}{{λ}_{1}} ) {β}_{1} , {γ}_{1}^{′} = ( \frac{{η}_{1}}{{μ}_{1}} ) {γ}_{1} , {δ}_{1}^{′} = ( \frac{1}{{μ}_{1}} ) {δ}_{1}$$

$${α}_{2}^{′} = ( \frac{{η}_{2}}{{λ}_{2}} ) {α}_{2} , {β}_{2}^{′} = ( \frac{1}{{λ}_{2}} ) {β}_{2} , {γ}_{2}^{′} = ( \frac{{η}_{2}}{{μ}_{2}} ) {γ}_{2} , {δ}_{2}^{′} = ( \frac{1}{{μ}_{2}} ) {δ}_{2}$$

$${α}_{3}^{′} = ( \frac{{η}_{3}}{{λ}_{3}} ) {α}_{3} , {β}_{3}^{′} = ( \frac{1}{{λ}_{3}} ) {β}_{3} , {γ}_{3}^{′} = ( \frac{{η}_{3}}{{μ}_{3}} ) {γ}_{3} , {δ}_{3}^{′} = ( \frac{1}{{μ}_{3}} ) {δ}_{3}$$

The calculation technique described above calculates a position deviation of three points by using a least squares method. At the end of the calculation by the least squares method, nonlinearity is compensated by multiplying a projection of a coordinate axis by a new scale factor. By using the new scale factor provided by three groups of equations, each of the constants α, β, γ, and δ described above is calculated again for each image plane. Then, calculation by the least squares method is performed again.

Hereinafter, a calculation method in which the calculation method described above is extended to a case where four or more reference points are used will be described. Herein, a case where four reference points are used is described. A position of each of the four reference points is acquired by setting up the equations (1) to (4) described above with regard to the four reference points on an assumption that each of the reference points is located on the X-Y plane in the SCS coordinate system as described above.

With regard to a case of a more generalized manner, similarly to the case where the equations (13) to (15) are acquired for the three reference points, x, y coordinates of the four reference points can be represented as linear functions of z as in equations (19) to (22) described below.

$$[ Mathematical 14 ]$$

$${x}_{1} = {α}_{1} {z}_{1} + {β}_{1} \qquad ( 19 )$$

$${y}_{1} = {γ}_{1} {z}_{1} + {δ}_{1}$$

$${x}_{2} = {α}_{2} {z}_{2} + {β}_{2} \qquad ( 20 )$$

$${y}_{2} = {γ}_{2} {z}_{2} + {δ}_{2}$$

$${x}_{3} = {α}_{3} {z}_{3} + {β}_{3} \qquad ( 21 )$$

$${y}_{3} = {γ}_{3} {z}_{3} + {δ}_{3}$$

$${x}_{4} = {α}_{4} {z}_{4} + {β}_{4} \qquad ( 22 )$$

$${y}_{4} = {γ}_{4} {z}_{4} + {δ}_{4}$$

Next, the following equations are acquired with regard to a distance between the origins in the four SCS coordinate systems and a distance between four measurement points (reference points), based on a fact that the workpiece W is a rigid body and a fact that the distance between the origins in the four SCS coordinate systems and the distance between the four reference points are equal. It should be noted that, it is described herein that a solution to the equations (19) to (22) is obtained by setting up equations with regard to d12, d23, d34, and d41 as a distance between the origins in the four SCS coordinate systems (distance between the four reference points), but a solution to the equations (19) to (22) may be obtained by further setting up equations with regard to d13 and d24 as a distance between the origins in the four SCS coordinate systems (distance between the four reference points) and also taking these equations into consideration.

$$[ Mathematical 15 ]$$

$${d}_{12} = {[ {x}_{O 12}^{2} + {y}_{O 12}^{2} + {z}_{O 12}^{2} ]}^{1 / 2}$$

$${d}_{23} = {[ {x}_{O 23}^{2} + {y}_{O 23}^{2} + {z}_{O 23}^{2} ]}^{1 / 2}$$

$${d}_{34} = {[ {x}_{O 34}^{2} + {y}_{O 34}^{2} + {z}_{O 34}^{2} ]}^{1 / 2}$$

$${d}_{41} = {[ {x}_{O 41}^{2} + {y}_{O 41}^{2} + {z}_{O 41}^{2} ]}^{1 / 2}$$

$$[ Mathematical 16 ]$$

$${d}_{12}^{2} = {( {x}_{O 12} + {x}_{1} - {x}_{2} )}^{2} + {( {y}_{O 12} + {y}_{1} - {y}_{2} )}^{2} + {( {z}_{O 12} + {z}_{1} - {z}_{2} )}^{2} \qquad ( 23 )$$

$${d}_{23}^{2} = {( {x}_{O 23} + {x}_{2} - {x}_{3} )}^{2} + {( {y}_{O 23} + {y}_{2} - {y}_{3} )}^{2} + {( {z}_{O 23} + {z}_{2} - {z}_{3} )}^{2}$$

$${d}_{34}^{2} = {( {x}_{O 34} + {x}_{3} - {x}_{4} )}^{2} + {( {y}_{O 34} + {y}_{3} - {y}_{4} )}^{2} + {( {z}_{O 34} + {z}_{3} - {z}_{4} )}^{2}$$

$${d}_{41}^{2} = {( {x}_{O 41} + {x}_{4} - {x}_{1} )}^{2} + {( {y}_{O 41} + {y}_{4} - {y}_{1} )}^{2} + {( {z}_{O 41} + {z}_{4} - {z}_{1} )}^{2}$$

By substituting the equations (19) to (22) for an equation (23), equations (24) and (25) by which the equations (17) and (18) described above are extended for the four reference points are acquired as follows.

$$[ Mathematical 17 ]$$

$${( {x}_{O 12} + {α}_{1} {z}_{1} + {β}_{1} - {α}_{2} {z}_{2} - {β}_{2} )}^{2} + {( {y}_{O 12} + {γ}_{1} {z}_{1} + {δ}_{1} - {γ}_{2} {z}_{2} - {δ}_{2} )}^{2} + {( {z}_{O 12} + {z}_{1} - {z}_{2} )}^{2} = {d}_{12}^{2} \qquad ( 24 )$$

$${( {x}_{O 23} + {α}_{2} {z}_{2} + {β}_{2} - {α}_{3} {z}_{3} - {β}_{3} )}^{2} + {( {y}_{O 23} + {γ}_{2} {z}_{2} + {δ}_{2} - {γ}_{3} {z}_{3} - {δ}_{3} )}^{2} + {( {z}_{O 23} + {z}_{2} - {z}_{3} )}^{2} = {d}_{23}^{2}$$

$${( {x}_{O 34} + {α}_{3} {z}_{3} + {β}_{3} - {α}_{4} {z}_{4} - {β}_{4} )}^{2} + {( {y}_{O 34} + {γ}_{3} {z}_{3} + {δ}_{3} - {γ}_{4} {z}_{4} - {δ}_{4} )}^{2} + {( {z}_{O 34} + {z}_{3} - {z}_{4} )}^{2} = {d}_{34}^{2}$$

$${( {x}_{O 41} + {α}_{4} {z}_{4} + {β}_{4} - {α}_{1} {z}_{1} - {β}_{1} )}^{2} + {( {y}_{O 41} + {γ}_{4} {z}_{4} + {δ}_{4} - {γ}_{1} {z}_{1} - {δ}_{1} )}^{2} + {( {z}_{O 41} + {z}_{4} - {z}_{1} )}^{2} = {d}_{41}^{2}$$

$$[ Mathematical 18 ]$$

$${k}_{11} {z}_{1}^{2} + {k}_{10} {z}_{1} + {k}_{20} {z}_{2} + {k}_{12} {z}_{1} {z}_{2} + {k}_{22} {z}_{2}^{2} + {k}_{00} = 0 \qquad ( 25 )$$

$${l}_{22} {z}_{2}^{2} + {l}_{20} {z}_{2} + {l}_{30} {z}_{3} + {l}_{23} {z}_{2} {z}_{3} + {l}_{33} {z}_{3}^{2} + {l}_{00} = 0$$

$${m}_{33} {z}_{3}^{2} + {m}_{30} {z}_{3} + {m}_{40} {z}_{4} + {m}_{34} {z}_{3} {z}_{4} + {m}_{44} {z}_{4}^{2} + {m}_{00} = 0$$

$${n}_{44} {z}_{4}^{2} + {n}_{40} {z}_{4} + {n}_{10} {z}_{1} + {n}_{41} {z}_{4} {z}_{1} + {n}_{11} {z}_{1}^{2} + {n}_{00} = 0$$

This equation is solved by the iterative method similarly to the case of the technique described above, and x1, x2, x3, x4 and y1, y2, y3, y4, i.e., positions of the four reference points after displacement can be acquired. Then, a three-dimensional position of the workpiece W is acquired by combining detected position of the four reference points. In other words, the transformation [T] that relates the VCS to the BCS is acquired from the detected positions.

It is also understood that the above calculation method can be extended, in a similar manner, to a case where the measurement is performed for the further increased number of detection targets (reference points).

It should be noted that various techniques can be used for determining a three-dimensional position of the workpiece W from detected positions of three or more detection targets (reference points). As an exemplification, various techniques as follows can be applied. It should also be noted that, in the techniques exemplified below, when there is a condition for arrangement of detection targets (reference points), the condition is followed.

(1) A technique for obtaining parameters of the transformation [T] described above (parameter representing translation and rotation) by solving simultaneous equations.

(2) A technique for specifying a position and a posture of a workpiece by applying a polygon having a known shape (polygon connecting reference points located in a zero deviation position) to a line of sight of a camera with respect to a detected position of each reference point as described in PTL 4 (Japanese Unexamined Patent Publication (Kokai) No. JP 2019-128274 A).

(3) A technique for recognizing a coordinate system on a workpiece by specifying a plane (such as an XY plane) of the coordinate system from positions of three or more reference points on the workpiece. In this case, for example, the coordinate system is recognized on an assumption that a first reference point is the origin, a second reference point is a position in an X-axis direction, and a third reference point (and fourth or subsequent reference points) is a position on the XY plane.

A calculation function of obtaining a three-dimensional position of the workpiece W from detected positions of three or more detection targets (reference points) in such a manner may be implemented as a function in selection unit 153 or three-dimensional position determination unit 154 in robot controller 50.

FIG. 5 is a functional block diagram of robot controller 50 and image processing device 20. As illustrated in FIG. 5, robot controller 50 includes motion control unit 151, combination generation unit 152, selection unit 153, and three-dimensional position determination unit 154. It should be noted that the functional blocks may be achieved by processor 51 of robot controller 50 executing a program. Further, robot controller 50 includes storage unit 155.

Storage unit 155 is formed of, for example, a non-volatile memory, a hard disk device, or the like. A motion program that controls robot 10, a program (vision program) that executes image processing such as detection of a workpiece based on an image captured by visual sensor 70, various types of setting information, and the like are stored in storage unit 155.

Motion control unit 151 controls a motion of a robot according to a motion program of the robot. Robot controller 50 includes a servo control unit (not illustrated) that performs servo control on a servo motor of each axis according to a command for each axis being generated by motion control unit 151. Motion control unit 151 has a function of moving visual sensor 70 and positioning visual sensor 70 in a capturing position for capturing each detection target.

Combination generation unit 152 provides a function of generating a plurality of combinations each of which is acquired by selecting three or more detection targets from among detection targets detected on workpiece W.

Selection unit 153 provides a function of selecting one or more combinations from the plurality of combinations, based on a “deviation amount” calculated from each of the plurality of generated combinations.

Three-dimensional position determination unit 154 provides a function of determining three-dimensional position information about workpiece W from the one or more combinations of the detection targets being selected by selection unit 153. Details of functions of combination generation unit 152, selection unit 153, and three-dimensional position determination unit 154 will be described below.

Image processing device 20 includes image processing unit 121 and storage unit 122. Storage unit 122 is a storage device formed of, for example, a non-volatile memory. Storage unit 122 stores various types of data needed for image processing, such as shape data about a detection target and calibration data. Image processing unit 121 executes various types of image processing such as detection processing of a workpiece. In other words, image processing unit 121 has a function as a detection unit that detects a detection target on an image captured by visual sensor 70 in a capturing range including the detection target.

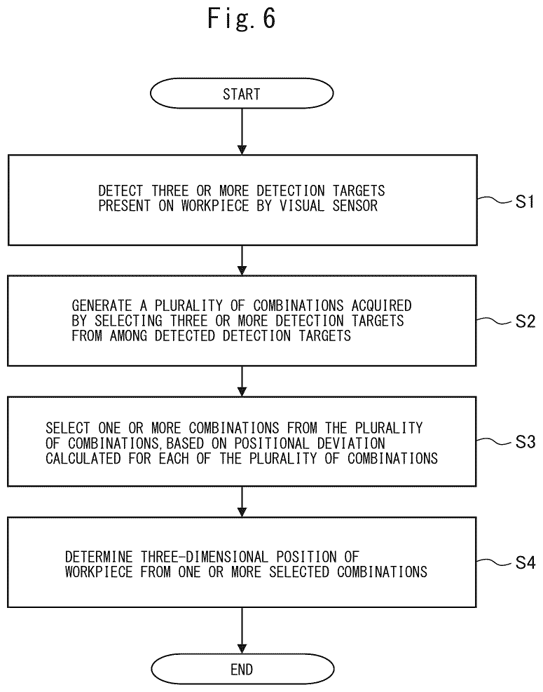

A three-dimensional measurement function of workpiece W by robot controller 50 will be described. FIG. 6 is a flowchart illustrating a basic operation of three-dimensional position measurement processing executed under control by robot controller 50 (processor 51).

First, image processing unit (detection unit) 121 detects a detection target, based on an image in which the detection target is captured by visual sensor 70 (step S1). Herein, visual sensor 70 is positioned in a capturing position for capturing each detection target by robot 10, and captures an image including the detection target. Image processing unit (detection unit) 121 acquires a position (x, y) of each of three or more detection targets by the position detection function described above.

Next, combination generation unit 152 generates a plurality of combinations each of which is acquired by selecting three or more detection targets from among the detected detection targets (step S2). For example, combination generation unit 152 may generate all possible combinations from the three or more detected detection targets. In this case, for example, when the number of the detected detection targets is five, the number of possible combinations is a total number of the number of combinations using all of the five detection targets, the number of combinations using four of the five detection targets, and the number of combinations using three of the five detection targets.

Alternatively, combination generation unit 152 may generate a combination of detection targets according to the rules as follows.
(Rule 1) A detection target to be excluded is selected from the three or more detected detection targets. However, at least three detection targets need to be left.
(Rule 2) A maximum number of detection targets to be excluded may be designated.
(Rule 3) A minimum number of detection targets to be left may be designated.

When a detection target to be excluded is selected, a combination of a plurality of detection targets may be generated by changing a detection target to be excluded. For example, when eight detection targets are detected, and designation of a maximum number to be excluded is two, (1+8+8×7÷2=37) combinations of detection results may be generated.

Combination generation unit 152 may be configured to accept an input of “selection of a detection target to be excluded”, a “maximum number of detection targets to be excluded”, or a “minimum number of detection targets to be left” (an input from an external device or a user input). A user interface for accepting a user input may be displayed on display unit 41 of teach pendant 40. A user input may be performed via the operation unit of teach pendant 40. Combination generation unit 152 may generate the combinations by using set values being preset in robot controller 50 for “selection of a detection target to be excluded”, a “maximum number of detection targets to be excluded”, or a “minimum number of detection targets to be left”.

In such a manner, by incorporating a greater number of detection targets into calculation of a three-dimensional position of the entire object (three-dimensional position of workpiece W), the influence of an error that may be included in each detection target can be reduced as a whole, and accuracy of measurement of a three-dimensional position can be increased.

Next, selection unit 153 calculates, for each of the generated combinations of the detection targets, a three-dimensional position of the entire object (three-dimensional position of workpiece W), and an indicator representing a positional deviation of detected positions of three or more detection targets included in the combination from an ideal position (hereinafter, the indicator is referred to as a “positional deviation”). Then, selection unit 153 selects one or more combinations, based on the “positional deviation” (step S3).

As an exemplification, selection unit 153 calculates the “positional deviation” as follows. It is assumed that a three-dimensional position of the entire object is obtained as a position A in regard to a certain combination. By using a design position Pi of an i-th detection target on workpiece W, an ideal position of the detection target when the three-dimensional position of workpiece W is the position A is obtained as A·Pi. The number of detection targets in this combination is assumed to be n. Selection unit 153 may calculate, for example, a positional deviation D, based on a difference Ki between A·Pi and a position P′i after displacement of the i-th detection target (reference point) being obtained in the equation (25) described above. For example, selection unit 153 may obtain the positional deviation D as an average value ΣKi/n of Ki. In this case, the positional deviation D is an indicator of a certain combination indicating an extent of a deviation amount of a detected position of a detection target included in the combination from an ideal position. Alternatively, selection unit 153 may calculate the positional deviation D, based on a distance Di between a line of sight Li to an actual detected position of the i-th detection target and A·Pi. For example, selection unit 153 may obtain the positional deviation D as an average ΣDi/n of Di. Also, in this case, the positional deviation D is an indicator of a certain combination indicating an extent of a deviation amount of a detected position of a detection target included in the combination from an ideal position.

Selection unit 153 can select one or more combinations, based on the positional deviation D calculated for each of the generated combinations. In this case, selection unit 153 can select a combination by using a selection criterion that (r1) accuracy is higher as the positional deviation D is smaller. Therefore, for example, selection unit 153 may select a predetermined number of combinations having a small value of the positional deviation D, or may select one combination having the smallest value of the positional deviation D.

In such a manner, with the configuration for selecting a combination used for calculation of a three-dimensional position of the entire object (three-dimensional position of workpiece W) based on the positional deviation D, a combination having a high possibility of having a great error can be excluded, and accuracy of measurement of a three-dimensional position can be increased.

Next, three-dimensional position determination unit 154 determines a final three-dimensional position of workpiece W from the one or more combinations selected by selection unit 153 (step S4). When the combination selected by selection unit 153 is one, three-dimensional position determination unit 154 may determine the position A of workpiece W obtained by the one combination as a final three-dimensional position of workpiece W.

When the plurality of combinations are selected by selection unit 153, three-dimensional position determination unit 154 may determine a final three-dimensional position of workpiece W, based on a statistic related to a three-dimensional position of workpiece W being obtained for each of the plurality of combinations. For example, three-dimensional position determination unit 154 may determine, as a final three-dimensional position of workpiece W, an average value or a median of a three-dimensional position of workpiece W being obtained for each of the plurality of selected combinations.

In such a manner, according to the three-dimensional position measurement processing in the present embodiment, the influence of an error can be reduced, and accuracy of measurement of a three-dimensional position of a three-dimensional object can be improved.

When a combination is selected in step S3 of the three-dimensional position measurement processing described above, selection unit 153 may further consider the number of detection targets in each of generated combinations. In this case, selection unit 153 may perform selection by using selection criteria that
(r1) accuracy is higher as the positional deviation D is smaller, and
(r2) accuracy is higher as the number of detection targets in a combination is greater. It should be noted that the selection criterion (r2) in this case is based on a fact that, as the number of detection targets is greater, an error that may be included in each of the detection targets may be rounded off and position measurement accuracy as a whole may be increased.

As one example, a situation where there are a plurality of selection candidates for a combination having an excellent (relatively small) positional deviation D is assumed. In this case, selection unit 153 may select one or a plurality of combinations having a great number of detection targets from among the plurality of selection candidates.

When a combination is generated in step S2 of the three-dimensional position measurement processing described above, combination generation unit 152 may output, as a generated combination, a specific combination selected from among combinations that can be generated from detected detection targets. For example, a situation where the number of detection targets detected in step S1 is great is considered. In this case, the number of combinations that can be generated is extremely great. In such a situation, combination generation unit 152 may output combinations randomly selected from among all the combinations that can be generated. In this case, a combination can be selected from a great number of combination candidates in a balanced manner and can be used.

In step S3 of the three-dimensional position measurement processing described above, a situation where a great number of combinations are selected based on the positional deviation D or based on the positional deviation D and the number of detection targets is considered. In this case, the number of the selected combinations may be narrowed down by further repeating the processing in steps S2 to S3 for one or more times for the selected combinations. In this case,
(1) regenerating, by combination generation unit 152, a plurality of combinations (a plurality of second combinations) each of which is acquired by selecting three or more detection targets, based on detection targets included in one or more combinations selected by selection unit 153, and
(2) reselecting, by selection unit 153, one or more combinations from the plurality of second combinations, based on an indicator (positional deviation) calculated for each of the plurality of second combinations, are performed for one or more times.

For example, when the number of detected detection targets is 20, and a combination is generated according to a rule that a “minimum number of detection targets to be left is ten” in generation of a combination for the first time by combination generation unit 152, the number of combinations selected by selection unit 153 is assumed to be a considerable number. In this case, combination generation unit 152 may apply, for example, a rule that a “minimum number of detection targets to be left is 15” to the detection targets included in the combinations being selected by selection unit 153, and may generate a plurality of second combinations. However, in this case, the plurality of second combinations are generated by setting the combinations preselected by selection unit 153 as a population, and selecting, from the population, a combination conforming to the rule that a “minimum number of detection targets to be left is 15”. Selection unit 153 may select a combination from the plurality of second combinations, based on the selection criterion (r1) described above or the selection criteria (r1) and (r2) described above.

Further, narrowing down of selections by repeating generation of a combination by combination generation unit 152 and selection by selection unit 153 may be performed as follows. Combination generation unit 152 regenerates a plurality of combinations including three or more detection targets by deleting, from one or more combinations selected by selection unit 153, one or more detected positions that satisfy a criterion that an indicator (for example, Ki or Di described above) representing a positional deviation calculated for a certain detected position is greater than an indicator representing a positional deviation calculated for another detected position, and combination generation unit 152 performs regeneration for one or more times until an indicator representing a positional deviation calculated for a detection target in each of the regenerated combinations satisfies a predetermined condition. In this case, the predetermined condition may be a condition that an average value of indicators representing positional deviations for detection targets in each of the regenerated combinations or a value of the indicator is equal to or less than a predetermined value.

Specifically, the operation may be performed as follows.

(b1) Combination generation unit 152 performs, for one or more times, an operation of regenerating a plurality of combinations including three or more detection targets by deleting, from one or more combinations selected by selection unit 153, one or more detected positions that satisfy a criterion that the “difference Ki calculated for a certain detected position is greater than the difference Ki calculated for another detected position”, (b2) in such a way that ΣKi/n or Ki for the generated combination is equal to or less than a predetermined value.
In (b1) described above, for example, processing of deleting a predetermined number of detection targets having a great difference Ki may be executed in regard to detection targets included in a certain combination.

Alternatively, narrowing down of selections by repeating generation of a combination by combination generation unit 152 and selection by selection unit 153 may be performed as follows.

(c1) Combination generation unit 152 performs, for one or more times, an operation of regenerating a plurality of combinations including three or more detection targets by deleting, from one or more combinations selected by selection unit 153, one or more detected positions that satisfy a criterion that the “distance Di calculated for a certain detected position is greater than the distance Di calculated for another detected position”, (c2) in such a way that ΣDi/n or Di for the generated combination is equal to or less than a predetermined value.
In (c1) described above, for example, processing of deleting a predetermined number of detection targets having a great distance Di may be executed in regard to detection targets included in a certain combination.

With the configuration for repeating selection in such a manner, particularly in a situation where the number of detection targets is great, suitable narrowing down of selection candidates can be performed at a high speed.

As described above, according to the present embodiment, the influence of an error that may be included in a detected position of a detection target can be reduced, and accuracy of measurement of a three-dimensional position of a three-dimensional object can be thus improved.

A functional arrangement in the functional block diagram illustrated in FIG. 3 is an example, and various modification examples of a functional distribution in robot system 100 are possible. For example, a configuration example in which a part of the functions in robot controller 50 is arranged on teach pendant 40 side is possible.

The entire function of teach pendant 40 and robot controller 50 may also be defined as the robot controller.

The configuration of the robot controller (including the case where the function of the image processing device is integrated) in the embodiment described above can be applied to controllers of various industrial machines.

The functional blocks of the robot controller and the image processing device illustrated in FIG. 5 may be achieved by executing various types of software stored in a storage device by the processor of the robot controller and the image processing device, or may be achieved by a configuration in which hardware such as an application specific integrated circuit (ASIC) is a main body.

The program for executing various types of processing such as the three-dimensional position measurement processing in the embodiment described above can be recorded in various computer-readable recording media (for example, a ROM, an EEPROM, a semiconductor memory such as a flash memory, a magnetic recording medium, and an optical disk such as a CD-ROM and a DVD-ROM).

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the embodiments and the modification examples described above, supplementary notes below are further described.

### (Supplementary Note 1)

A controller (50) including:
a combination generation unit (152) configured to generate a plurality of combinations each of which is acquired by selecting three or more detection targets from among detection targets detected based on an image in which three or more detection targets being present on a workpiece and having a known positional relationship with one another are captured by a visual sensor (70);
a selection unit (153) configured to select one or more combinations from the plurality of combinations, based on an indicator representing a positional deviation of detected positions of the three or more detection targets from an ideal position, the indicator being calculated for each of the plurality of generated combinations; and
a three-dimensional position determination unit (154) configured to determine a three-dimensional position of the workpiece from the one or more selected combinations.

### (Supplementary Note 2)

The controller (50) according to supplementary note 1, wherein
the combination generation unit (152) generates all of the combinations being possible from the detected detection targets.

### (Supplementary Note 3)

The controller (50) according to supplementary note 1, wherein
the combination generation unit (152) generates the plurality of combinations by excluding or selecting a predetermined number of detection targets from the detected detection targets.

### (Supplementary Note 4)

The controller (50) according to supplementary note 1, wherein
the combination generation unit (152) generates the plurality of combinations by randomly selecting combinations from the combinations that can be generated from the detected detection targets.

### (Supplementary Note 5)

The controller (50) according to any one of supplementary notes 1 to 4, wherein,
for each of the plurality of generated combinations, the selection unit (153)
(1) obtains, as A·Pi, an ideal position of an i-th detection target on the workpiece when a three-dimensional position of the workpiece obtained from one combination is a position A and a design position of the i-th detection target on the workpiece is Pi, and
(2) obtains, for each detection target in the one combination, a difference Ki between a detected position P′i of the i-th detection target in the one combination and A·Pi, and obtains the indicator, based on the obtained difference Ki.

### (Supplementary Note 6)

The controller (50) according to supplementary note 5, wherein
the selection unit (153) obtains, as the indicator, Ki/n being an average value of the difference Ki when the number of detection targets in the one combination is n.

### (Supplementary Note 7)

The controller (50) according to any one of supplementary notes 1 to 4, wherein,
for each of the plurality of generated combinations, the selection unit (153)
(1) obtains, as A·Pi, an ideal position of an i-th detection target on the workpiece when a three-dimensional position of the workpiece obtained from one combination is a position A and a design position of the i-th detection target on the workpiece is Pi, and
(2) obtains, for each detection target in the one combination, a distance Di between a line of sight Li to a detected position of the i-th detection target from the visual sensor in the one combination and A·Pi, and obtains the indicator, based on the obtained distance Di.

### (Supplementary Note 8)

The controller (50) according to supplementary note 7, wherein
the selection unit (153) obtains, as the indicator, ΣDi/n being an average value of the distance Di when the number of detection targets in the one combination is n.

### (Supplementary Note 9)

The controller (50) according to any one of supplementary notes 1 to 8, wherein
the selection unit (153) performs selection of the one or more combinations by using a selection criterion that accuracy is higher as magnitude of the indicator is smaller.

### (Supplementary Note 10)

The controller (50) according to any one of supplementary notes 1 to 8, wherein
the selection unit (153) selects one or more combinations from the plurality of combinations, based on the indicator calculated for each of the plurality of combinations and the number of detection targets in each of the plurality of combinations.

### (Supplementary Note 11)

The controller (50) according to supplementary note 10, wherein,
for each of the plurality of combinations, the selection unit (153) performs selection of the one or more combinations by using selection criteria that
(1) accuracy is higher as magnitude of the indicator is smaller, and
(2) accuracy is higher as the number of detection targets in a combination is greater.

### (Supplementary Note 12)

The controller (50) according to any one of supplementary notes 1 to 11, wherein
the three-dimensional position determination unit (154) determines a three-dimensional position of the workpiece, based on a statistic of a three-dimensional position of the workpiece being acquired from each of the one or more selected combinations.

### (Supplementary Note 13)

The controller (50) according to supplementary note 12, wherein
the three-dimensional position determination unit (154) determines, as a three-dimensional position of the three-dimensional object, an average value or a median of a three-dimensional position of the workpiece being acquired from each of the one or more selected combinations.

### (Supplementary Note 14)

The controller (50) according to any one of supplementary notes 1 to 13, wherein
operations of
regenerating, by the combination generation unit (152), a plurality of combinations each of which is acquired by selecting three or more detection targets, based on detection targets included in the one or more combinations selected by the selection unit (153), and
reselecting, by the selection unit (153), one or more combinations from the plurality of regenerated combinations, based on the indicator calculated for each of the plurality of regenerated combinations,
are performed for one or more times.

### (Supplementary Note 15)

The controller (50) according to any one of supplementary notes 1 to 4, wherein
the combination generation unit (152) regenerates a plurality of combinations each of which includes three or more detection targets by deleting, from the one or more combinations selected by the selection unit (153), one or more detected positions that satisfy a criterion that an indicator representing the positional deviation calculated for a certain detected position is greater than an indicator representing the positional deviation calculated for another detected position, and the combination generation unit performs regeneration for one or more times until an indicator representing the positional deviation calculated for the detection target in each of regenerated combinations satisfies a predetermined condition.

### (Supplementary Note 16)

The controller (50) according to supplementary note 15, wherein
the predetermined condition is a condition that an average value of indicators representing the positional deviations for the detection targets in each of regenerated combinations or a value of the indicator is equal to or less than a predetermined value.

### (Supplementary Note 17)

A three-dimensional position measurement system (100) including:
a visual sensor (70);
a detection unit (121) configured to detect three or more detection targets being present on a workpiece and having a known positional relationship with one another, based on an image captured by the visual sensor;
a combination generation unit (152) configured to generate a plurality of combinations each of which is acquired by selecting three or more detection targets from among detected detection targets;
a selection unit (153) configured to select one or more combinations from the plurality of combinations, based on an indicator representing a positional deviation of detected positions of the three or more detection targets from an ideal position, the indicator being calculated for each of the plurality of generated combinations; and
a three-dimensional position determination unit (154) configured to determine a three-dimensional position of the workpiece from the one or more selected combinations.

### (Supplementary Note 18)

The three-dimensional position measurement system (100) according to supplementary note 17, further including:
a robot (10) on which the visual sensor (70) is mounted; and
a motion control unit (151) configured to control the robot (10), and positions the visual sensor (70) in a capturing position for capturing each of the three or more detection targets.

### (Supplementary Note 19)

A program for causing a processor of a computer to execute:
a step of detecting three or more detection targets being present on a workpiece and having a known positional relationship with one another, based on an image captured by a visual sensor (70);
a step of generating a plurality of combinations each of which is acquired by selecting three or more detection targets from among detected detection targets;
a step of selecting one or more combinations from the plurality of combinations, based on an indicator representing a positional deviation of detected positions of the three or more detection targets from an ideal position, the indicator being calculated for each of the plurality of generated combinations; and
a step of determining a three-dimensional position of the workpiece from the one or more selected combinations.

### REFERENCE SIGNS LIST

1 Table
10 Robot
20 Image processing device
33 Hand
40 Teach pendant
41 Display unit
50 Robot controller
51 Processor
70 Visual sensor
100 Robot system
121 Image processing unit
122 Storage unit
151 Motion control unit
152 Combination generation unit
153 Selection unit
154 Three-dimensional position determination unit
155 Storage unit

1. A controller comprising:
a combination generation unit configured to generate a plurality of combinations each of which is acquired by selecting detection targets from among detection targets detected based on an image in which three or more detection targets being present on a workpiece and having a known positional relationship with one another are captured by a visual sensor;
a selection unit configured to select one or more combinations from the plurality of combinations, based on an indicator representing a positional deviation of detected positions of the detection targets from an ideal position, the indicator being calculated for each of the plurality of generated combinations; and
a three-dimensional position determination unit configured to determine a three-dimensional position of the workpiece from the one or more selected combinations.

2. The controller according to claim 1, wherein
the combination generation unit generates all of the combinations being possible from the detected detection targets.

3. The controller according to claim 1, wherein
the combination generation unit generates the plurality of combinations by excluding or selecting a predetermined number of detection targets from the detected detection targets.

4. The controller according to claim 1, wherein
the combination generation unit generates the plurality of combinations by randomly selecting combinations from the combinations that can be generated from the detected detection targets.

5. The controller according to claim 1, wherein,
for each of the plurality of generated combinations, the selection unit
(1) obtains, as A·Pi, an ideal position of an i-th detection target on the workpiece when a three-dimensional position of the workpiece obtained from one combination is a position A and a design position of the i-th detection target on the workpiece is Pi, and
(2) obtains, for each detection target in the one combination, a difference Ki between a detected position P′i of the i-th detection target in the one combination and A·Pi, and obtains the indicator based on the obtained difference Ki.

6. The controller according to claim 5, wherein
the selection unit obtains, as the indicator, ΣKi/n being an average value of the difference Ki when the number of detection targets in the one combination is n.

7. The controller according to claim 1, wherein,
for each of the plurality of generated combinations, the selection unit
(1) obtains, as A·Pi, an ideal position of an i-th detection target on the workpiece when a three-dimensional position of the workpiece obtained from one combination is a position A and a design position of the i-th detection target on the workpiece is Pi, and
(2) obtains, for each detection target in the one combination, a distance Di between a line of sight Li to a detected position of the i-th detection target from the visual sensor in the one combination and A·Pi, and obtains the indicator based on the obtained distance Di.

8. The controller according to claim 7, wherein
the selection unit obtains, as the indicator, ΣDi/n being an average value of the distance Di when the number of detection targets in the one combination is n.

9. The controller according to claim 1, wherein
the selection unit performs selection of the one or more combinations by using a selection criterion that accuracy is higher as magnitude of the indicator is smaller.

10. The controller according to claim 1, wherein
the selection unit selects one or more combinations from the plurality of combinations, based on the indicator calculated for each of the plurality of combinations and the number of detection targets in each of the plurality of combinations.

11. The controller according to claim 10, wherein,
for each of the plurality of combinations, the selection unit performs selection of the one or more combinations by using selection criteria that
(1) accuracy is higher as magnitude of the indicator is smaller, and
(2) accuracy is higher as the number of detection targets in a combination is greater.

12. The controller according to claim 1, wherein
the three-dimensional position determination unit determines a three-dimensional position of the workpiece, based on a statistic of a three-dimensional position of the workpiece being acquired from each of the one or more selected combinations.

13. The controller according to claim 12, wherein
the three-dimensional position determination unit determines, as a three-dimensional position of the workpiece, an average value or a median of a three-dimensional position of the workpiece being acquired from each of the one or more selected combinations.

14. The controller according to claim 1, wherein
operations of
regenerating, by the combination generation unit, a plurality of combinations each of which is acquired by selecting three or more detection targets, based on detection targets included in the one or more combinations selected by the selection unit, and
reselecting, by the selection unit, one or more combinations from the plurality of regenerated combinations, based on the indicator calculated for each of the plurality of regenerated combinations,
are performed for one or more times.

15. The controller according to claim 1, wherein
the combination generation unit regenerates a plurality of combinations each of which includes detection targets by deleting, from the one or more combinations selected by the selection unit, one or more detected positions that satisfy a criterion that an indicator representing the positional deviation calculated for a certain detected position is greater than an indicator representing the positional deviation calculated for another detected position, and the combination generation unit performs regeneration for one or more times until an indicator representing the positional deviation calculated for the detection target in each of regenerated combinations satisfies a predetermined condition.

16. The controller according to claim 15, wherein
the predetermined condition is a condition that an average value of indicators representing the positional deviations for the detection targets in each of regenerated combinations or a value of the indicator is equal to or less than a predetermined value.

17. A three-dimensional position measurement system comprising:
a visual sensor;
a detection unit configured to detect three or more detection targets being present on a workpiece and having a known positional relationship with one another, based on an image captured by the visual sensor;
a combination generation unit configured to generate a plurality of combinations each of which is acquired by selecting detection targets from among detected detection targets;
a selection unit configured to select one or more combinations from the plurality of combinations, based on an indicator representing a positional deviation of detected positions of the detection targets from an ideal position, the indicator being calculated for each of the plurality of generated combinations; and
a three-dimensional position determination unit configured to determine a three-dimensional position of the workpiece from the one or more selected combinations.

18. The three-dimensional position measurement system according to claim 17, further comprising:
a robot on which the visual sensor is mounted; and
a motion control unit configured to control the robot, and positions the visual sensor in a capturing position for capturing each of the three or more detection targets.

19. A non-transitory computer readable storage medium storing instructions that, when executed by a processor of a computer, cause the processor to perform:
detecting three or more detection targets being present on a workpiece and having a known positional relationship with one another, based on an image captured by a visual sensor;
generating a plurality of combinations each of which is acquired by selecting detection targets from among detected detection targets;
selecting one or more combinations from the plurality of combinations, based on an indicator representing a positional deviation of detected positions of the detection targets from an ideal position, the indicator being calculated for each of the plurality of generated combinations; and
determining a three-dimensional position of the workpiece from the one or more selected combinations.
